(19) United States
(12) Patent Application Publication
(10) Pub. No.: US 2024/0151362 A1
(43) Pub. Date: May 9, 2024

(54) ADSORBENT SYSTEM AND CRYOGENIC SHIPPING CONTAINER INCLUDING THE SAME

(71) Applicant: IC BIOMEDICAL, LLC, CARTERSVILLE, GA (US)

(72) Inventors: IAN POPE, FARIBAULT, MN (US); ANDREW SAN GIACOMO, CORCORAN, MN (US)

(21) Appl. No.: 18/501,121

(22) Filed: Nov. 3, 2023

Related U.S. Application Data
(60) Provisional application No. 63/422,157, filed on Nov. 3, 2022.

(51) Int. Cl. F17C 11/00; F17C 6/00

(52) U.S. Cl. CPC F17C 11/00; F17C 6/00; F17C 2203/0391; F17C 2203/0629; F17C 2223/0161

(57) ABSTRACT

An adsorbent system and a dry vapor cryogenic shipping container are provided. The container includes an outer shell surrounding an inner vessel with an evacuable space therebetween. The container includes the adsorbent system, which includes a primary adsorbent disposed within an interior of the inner vessel and a secondary adsorbent that is disposed within the interior of the inner vessel adjacent a portion of a bottom wall of the inner vessel. The primary adsorbent and the secondary adsorbent adsorb a liquid cryogen, such as liquid nitrogen, at different rates. The primary adsorbent has a liquid cryogen adsorption rate that allows the container to be charged quickly with liquid cryogen, while the secondary adsorbent has a liquid cryogen adsorption rate that is less than the primary adsorbent and adsorbs liquid cryogen that may desorb from the primary adsorbent.

### CROSS-REFERENCE TO RELATED APPLICATIONS

The present application claims the benefit of U.S. Provisional Application Ser. No. 63/422,157, filed on Nov. 3, 2022, entitled ADSORBENT SYSTEM AND CRYOGENIC SHIPPING CONTAINER INCLUDING THE SAME, the entire disclosure of which is incorporated herein by reference in its entirety.

### FIELD

The present disclosure relates to cryogenic shipping containers. More particularly, the present disclosure relates to a dry vapor cryogenic shipping container that includes an adsorbent system having two different liquid cryogen adsorbent materials.

### BACKGROUND

Dry vapor cryogenic shipping containers are devices that use a liquid cryogen, typically liquid nitrogen, adsorbed into an adsorbent material contained inside a vacuum insulated vessel to provide storage temperatures of less than −150° C. for a period of at least 3 days to enable shipping of temperature sensitive materials, such as live cells, vaccines, semen, eggs, embryos, infectious substances, and so forth. Liquid nitrogen is considered a hazardous material and, therefore, is subject to various shipping regulations and restrictions.

A properly prepared dry vapor cryogenic shipping container does not contain any free liquid nitrogen and, thus, is not subject to the shipping regulations and restrictions that apply for liquid nitrogen. However, dry vapor cryogenic shipping containers that, for one reason or another, come to contain even small amounts of free liquid nitrogen are subject to the liquid nitrogen shipping regulations and restrictions as well as additional fees imposed by the shipping company.

### SUMMARY

Disclosed herein is a dry vapor cryogenic shipping container and an adsorbent system for a dry vapor shipping container. To illustrate various aspects of the present disclosure, exemplary embodiments of a dry vapor cryogenic shipping container and an adsorbent system for a dry vapor shipping container are provided herein.

In accordance with one aspect of the present disclosure, a dry vapor cryogenic shipping container is provided. The shipping container includes an inner vessel having an interior volume defined by at least one sidewall and a bottom wall. An outer shell surrounds and is separated from the inner vessel to define an evacuable space between the outer shell and the inner vessel. The shipping container also includes an adsorbent system. The adsorbent system includes a primary adsorbent having a first liquid cryogen adsorption rate disposed within the interior volume of the inner vessel and a secondary adsorbent having a second liquid cryogen adsorption rate disposed within the interior volume of the inner vessel. A ratio of the first liquid cryogen adsorption rate to the second liquid cryogen adsorption rate is from 2:1 to 10:1.

In some implementations of the dry vapor cryogenic shipping container, the ratio of the first liquid cryogen adsorption rate to the secondary liquid cryogen adsorption rate is from 4:1 to 6:1. In some implementations of the dry vapor cryogenic shipping container, a ratio of a mass of the primary adsorbent to a mass of the secondary adsorbent is from 1:22 to 1:5. In some implementations of the dry vapor cryogenic shipping container, a ratio of a volume of the primary adsorbent to a volume of the secondary adsorbent is from 1:1 to 4:1

In some implementations of the dry vapor cryogenic shipping container, the primary adsorbent comprises an aerogel and the secondary adsorbent comprises a fumed metal oxide. In some implementations of the dry vapor cryogenic shipping container, the primary adsorbent comprises an aerogel reinforced composite and the secondary adsorbent comprises at least one of a fumed silica and a fumed calcium silicate. In some implementations of the dry vapor cryogenic shipping container, at least one of the primary adsorbent and the secondary adsorbent are contained within a porous enclosure. In some implementations of the dry vapor cryogenic shipping container, at least a portion of the secondary adsorbent is positioned adjacent the bottom wall.

In accordance with one aspect of the present disclosure, an adsorbent system for a dry vapor cryogenic shipping container is provided. The adsorbent system has a primary adsorbent having a first liquid cryogen adsorption rate and a secondary adsorbent having a second liquid cryogen adsorption rate. A ratio of the first liquid cryogen adsorption rate to the second liquid cryogen adsorption rate is from 2:1 to 10:1.

In some implementations of the adsorbent system, the ratio of the first liquid cryogen adsorption rate to the secondary liquid cryogen adsorption rate is from 4:1 to 6:1. In some implementations of the adsorbent system, the primary adsorbent comprises an aerogel and the secondary adsorbent comprises a fumed metal oxide. In some implementations of the adsorbent system, the primary adsorbent comprises an aerogel reinforced composite and the secondary adsorbent comprises at least one of a fumed silica and a fumed calcium silicate. In some implementations of the adsorbent system, the primary adsorbent and the secondary adsorbent are provided as separate articles. In some implementations of the adsorbent system, the primary adsorbent and the secondary adsorbent are provided as a unitary article.

In some implementations of the adsorbent system, at least one of the primary adsorbent and the secondary adsorbent are contained within a porous enclosure. In some implementations of the adsorbent system, the primary adsorbent comprises an aerogel reinforced composite attached to the porous enclosure. In some implementations of the adsorbent system, the primary adsorbent comprises at least one porous enclosure containing the aerogel and the secondary adsorbent comprises at least one secondary porous enclosure containing the fumed metal oxide, and wherein the at least one porous of the primary adsorbent is attached to the at least one porous enclosure of the secondary adsorbent.

In accordance with one aspect of the present disclosure, a method of storing a liquid cryogen in a dry vapor cryogenic shipping container is provided. The shipping container includes a primary adsorbent having a first liquid cryogen adsorption rate and a secondary adsorbent having a second liquid cryogen adsorption rate, wherein a ratio of the first liquid cryogen adsorption rate to the second liquid cryogen adsorption rate is from 2:1 to 10:1. The method includes steps of filling an inner vessel of the shipping container with the liquid cryogen, waiting for the primary adsorbent to be fully charged with liquid cryogen, and closing the shipping container after the primary adsorbent is fully charged with the liquid cryogen and before the secondary adsorbent is fully charged with the liquid cryogen.

In some implementations of the method, the primary adsorbent is fully charged with the liquid cryogen after 2 hours to 4 hours.

In some implementations, the method includes a step of emptying unabsorbed liquid cryogen from the shipping container prior to the step of closing the shipping container.

Other aspects, advantages, and features of the inventive concepts of the present disclosure will become apparent to those skilled in the art from the following detailed description, when read in light of the accompanying drawings.

### BRIEF DESCRIPTION OF THE DRAWINGS

FIG. 1 is a schematic plan view of an exemplary embodiment of an adsorbent system for a dry vapor cryogenic shipping container in accordance with the present disclosure.

FIG. 1A is a cross-sectional view of the adsorbent system for a dry vapor cryogenic shipping container of FIG. 1 along section line 1A-1A.

FIG. 2 is a schematic plan view of an exemplary embodiment of an adsorbent system for a dry vapor cryogenic shipping container in accordance with the present disclosure.

FIG. 2A is a cross-sectional view of the adsorbent system for a dry vapor cryogenic shipping container of FIG. 2 along section line 2A-2A.

FIG. 3 is a cross-sectional view of an exemplary embodiment of a dry vapor cryogenic shipping container of the present disclosure.

FIG. 4 is a cross-sectional view of an exemplary embodiment of a dry vapor cryogenic shipping container of the present disclosure.

### DETAILED DESCRIPTION

Disclosed herein are dry vapor cryogenic shipping containers and adsorbent systems for dry vapor cryogenic shipping containers. While the present disclosure describes certain embodiments of the foregoing devices in detail, the present disclosure is to be considered exemplary and is not intended to be limited to the disclosed embodiments.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Additionally, as used herein, the term “exemplary” is intended to mean serving as an illustration or example of something and is not intended to indicate a preference.

Numerical values or ranges stated herein are understood to encompass values at or near the stated value and/or above or below the stated range. For this application, the stated value can encompass plus or minus 5% of the value and the stated range can encompass plus or minus 5% of the extent of the range. In addition, the stated value or range can include a margin of error for the value or range typical in the art for the property being measured. The stated value or range can also encompass those values and ranges that would be considered equivalent to the stated value or range by one of ordinary skill in the art. As an example, a duration expressed as a range of 5 to 10 hours is understood to include durations above and below the ends of the range by 5% of the extent of the 5-hour range—e.g., 4 hours and 45 minutes to 10 hours and 15 minutes. As another example, the size of a particle expressed as a value of 5 mm includes values above and below 5 mm that are within the margin of error of a tool typically used to measure particles of that size. As yet another example, the density of a material expressed as a value of 5 g/cm³ includes values above and below 5 g/cm³ that would be considered equivalent by one of ordinary skill in the art.

One type of conventional dry vapor cryogenic shipping container utilizes an adsorbent system that includes a silica or silicate based adsorbent material, such as Cab-O-Sil® hydrophobic fumed silica from Cabot Corporation (Boston, Massachusetts). One problem associated with the silica or silicate based adsorbent material is that it typically requires from 18 hours to 24 hours to fully charge the adsorbent material with a liquid cryogen, such as liquid nitrogen. The problem of slow charging times was overcome by dry vapor cryogenic shipping containers that include a so-called quick charging adsorbent system, which utilizes an aerogel based adsorbent material that can be fully charged with liquid nitrogen in 2 hours. However, it has been discovered that the quick charging adsorbent system, after being fully charged, has a tendency over time to desorb some of the liquid nitrogen, which brings the dry vapor cryogenic shipping container within the purview of the hazardous material shipping regulations and restrictions, as well as the penalties and fees associated therewith.

The dry vapor cryogenic shipping containers and adsorbent systems of the present disclosure solve the problem associated with desorption of a liquid cryogen in a dry vapor cryogenic shipping container that includes a quick charging adsorbent system. In particular, the problem is solved by an adsorbent system that comprises a primary adsorbent having a first liquid cryogen adsorption rate and a secondary adsorbent having a second liquid cryogen adsorption rate, wherein a ratio of the first liquid cryogen adsorption rate to the second liquid cryogen adsorption rate is from 2:1 to 10:1. When used in a dry vapor cryogenic shipping container, the primary adsorbent adsorbs a liquid cryogen at an adsorption rate that enables the container to be fully charged with liquid cryogen in 2 hours to 4 hours. The secondary adsorbent, which adsorbs the liquid cryogen at a slower rate than the primary adsorbent, is positioned within the dry vapor shipping container such that any liquid cryogen that may desorb from the primary adsorbent will be adsorbed by the secondary adsorbent. Due to the differences in adsorption rate, when the dry vapor shipping container is fully charged with liquid cryogen, the primary adsorbent will be saturated with liquid cryogen while the secondary adsorbent will not be saturated and, thus, the secondary adsorbent will have capacity to adsorb liquid cryogen that may desorb from the primary adsorbent. Accordingly, the primary adsorbent and the secondary adsorbent work synergistically to ensure fast charging of a liquid cryogen (e.g., 2 hours to 4 hours), while also ensuring that the dry vapor shipping container maintains a “dry” condition (i.e., no free liquid cryogen present in the dry vapor shipping container) after charging.

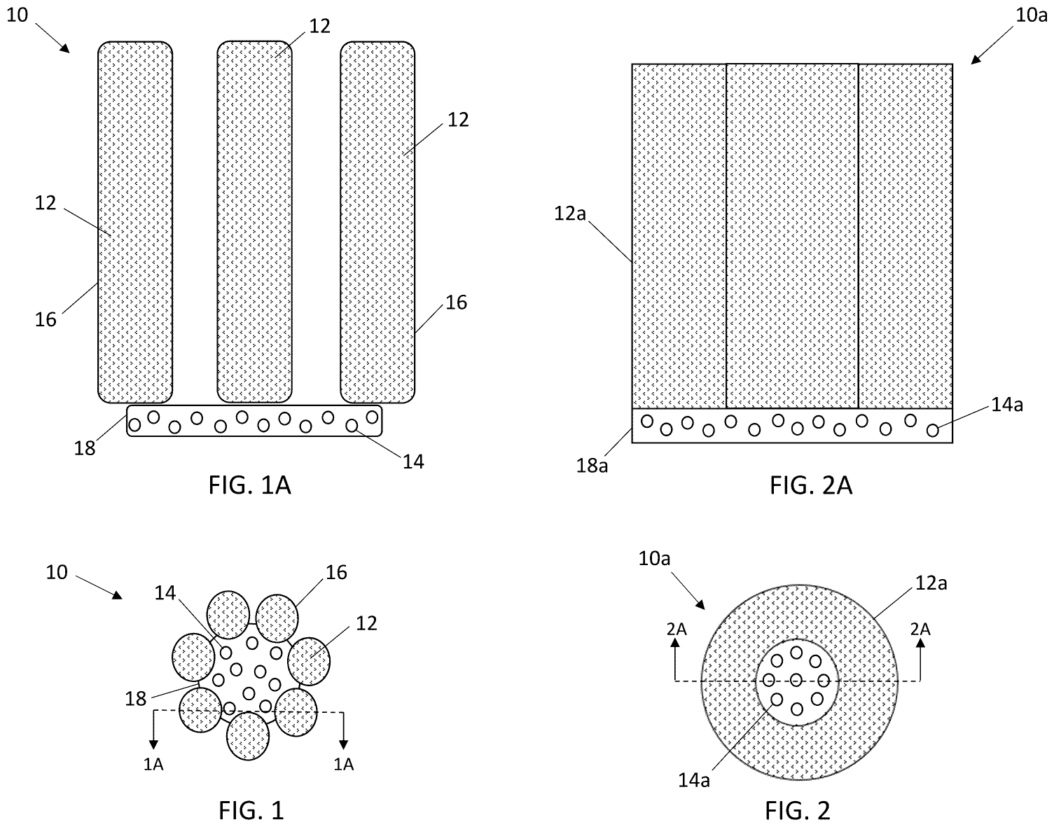

Referring now to FIGS. 1 and 1A, an adsorbent system 10 for a dry vapor cryogenic shipping container is shown. The adsorbent system 10 includes a primary adsorbent 12 having a first liquid cryogen adsorption rate and a secondary adsorbent 14 having a second liquid cryogen adsorption rate. A ratio of the first liquid cryogen adsorption rate to the second liquid cryogen adsorption rate ranges from 2:1 to 10:1. In certain aspects, the ratio of the first liquid cryogen adsorption rate to the second liquid cryogen adsorption rate ranges from 2:1 to 9:1, from 2:1 to 8:1, from 3:1 to 7:1, and also including from 4:1 to 6:1. Although the terms “adsorbent” and “adsorption” are used throughout the present disclosure, it should be understood that these phrases are also intended to encompass the retention of a liquid cryogen, such as liquid nitrogen, via mechanisms such as absorption and capillarity.

In certain aspects of the present disclosure, the primary adsorbent 12 comprises an aerogel. Aerogels are solid materials that have a highly porous network of micro-sized and meso-sized pores. The porosity of an aerogel may be at least 75%, including at least 80%, at least 85%, at least 90%, at least 95%, and also including at least 97%. A typical pore size distribution for an aerogel may be in the range of 1 nanometer (nm) to 500 nm. Due to its highly porous structure, aerogels also have a very low density (e.g., 0.001 g/cm³ to 0.8 g/cm³) as well as a high specific surface area (e.g., 500 m²/g to 1,300 m²/g). The physical properties associated with aerogels, particularly the high porosity and high specific surface area, render them especially well-suited for adsorbing a liquid cryogen, such as liquid nitrogen.

Aerogels may be formed from a variety of materials. Exemplary materials used to form aerogels include, but are not limited to, silica, alumina, zirconia, yttria, hafnia, titania, ceria, carbides, carbon, polymers (e.g., phenolics, polyureas, polyurethanes, polyimides, polyamides), and combinations thereof. In addition, aerogels may be provided in a variety of forms. Exemplary forms of aerogels include, but are not limited to, monoliths (i.e., shaped forms), chunks (e.g., average particle size of 0.5 mm to 10 mm), powders (e.g., average particle size of 50 μm to 200 μm), films, and reinforced composites.

The primary adsorbent 12 may comprise at least one of a silica-based aerogel, an alumina-based aerogel, a zirconia-based aerogel, a yttria-based aerogel, a hafnia-based aerogel, a titania-based aerogel, a ceria-based aerogel, a carbide-based aerogel, a carbon-based aerogel, a polymer-based aerogel, or combinations thereof. In certain aspects of the present disclosure, the primary adsorbent 12 comprises any one or more of the aforementioned aerogels in the form of a monolith, a powder, chunks, a film, a reinforced composite, or combinations thereof. When the aerogel is in powder or chunk form, at least one porous enclosure 16 may be used to retain the aerogel powder or chunks. The porous enclosures 16 may comprise a polymer including, but not limited to, a polyamide (e.g., a nylon), a polyaramid (e.g., Nomex® meta-aramid), and a polyimide. The porous enclosures 16 may be formed in any desirable shape including, but not limited to, a cylinder or tube, a disk, a torus (or donut), a cuboid, a sphere, a cone, and a hollow cylinder. In certain aspects, the primary adsorbent 12 comprises at least one porous enclosure 16 containing any one or more of the aforementioned aerogels in the form of a powder, chunks, or combinations thereof.

In certain aspects of the present disclosure, the primary adsorbent 12 comprises an aerogel reinforced composite. The aerogel reinforced composite includes a fiber reinforcement impregnated with an aerogel, such as any one or more of the previously mentioned aerogels. In certain aspects, the aerogel reinforced composite comprises a fiber reinforcement impregnated with a silica-based aerogel. Exemplary fiber reinforcements include, but are not limited to, non-woven mats, woven mats, and non-woven batting. The fiber reinforcement may include glass fibers, polymer fibers, carbon fibers, ceramic fibers, or combinations thereof. An example of a commercially available silica-based aerogel reinforced composite suitable for use as the primary adsorbent 12 is Pyrogel® aerogel blanket from Aspen Aerogels, Inc. (Northborough, Massachusetts).

As mentioned above, the primary adsorbent 12 adsorbs a liquid cryogen at a first liquid cryogen adsorption rate that enables a dry vapor cryogen shipping to be fully charged with a liquid cryogen in 2 hours to 4 hours. In certain aspects, the primary adsorbent 12 has a first liquid cryogen adsorption rate of 1 L/hr per unit volume of adsorbent to 5 L/hr per unit volume of adsorbent. In certain aspects, the primary adsorbent 12 has a first liquid cryogen adsorption rate of 1.25 L/hr per unit volume of adsorbent to 4.5 L/hr per unit volume of adsorbent, including from 1.5 L/hr per unit volume of adsorbent to 4 L/hr per unit volume of adsorbent, from 1.75 L/hr per unit volume of adsorbent to 3.5 L/hr per unit volume of adsorbent, from 2 L/hr per unit volume of adsorbent to 3 L/hr per unit volume of adsorbent, from 2.25 L/hr per unit volume of adsorbent to 2.75 L/hr per unit volume of adsorbent, and also including from 2.4 L/hr per unit volume of adsorbent to 2.6 L/hr per unit volume of adsorbent. The cryogen adsorption rates disclosed herein can be determined by taking a known volume (or weight) of adsorbent and submerging it in a liquid cryogen (e.g., liquid nitrogen) and removing the adsorbent from the liquid cryogen and weighing it every hour.

In certain aspects of the present disclosure, the secondary adsorbent 14 comprises a fumed metal oxide. Exemplary fumed metal oxides suitable for use as the secondary adsorbent 14 include, but are not limited to, fumed silica, fumed alumina, fumed titania, fumed ceria, fumed zirconia, fumed magnesia, salts thereof (e.g., fumed calcium silicate) and combinations thereof. Fumed metal oxides are typically provided as a powder. At least one porous enclosure 18 may be used to retain the fumed metal oxide. The porous enclosures 18 may comprise a polymer including, but not limited to, a polyamide (e.g., a nylon), a polyaramid (e.g., Nomex® meta-aramid), and a polyimide. The porous enclosures 18 may be formed in any desirable shape including, but not limited to, a cylinder or tube, a disk, a torus (or donut), a cuboid, a sphere, a cone, and a hollow cylinder.

In certain aspects, the secondary adsorbent 14 comprises a fumed silica, a fumed calcium silicate, or combinations thereof. In certain aspects, the secondary adsorbent 14 comprises a porous enclosure 18 containing a fumed silica, a fumed calcium silicate, or combinations thereof.

As mentioned above, the secondary adsorbent 14 adsorbs liquid cryogen at a slower rate than the primary adsorbent 12. When the secondary adsorbent 14 is used in a dry vapor cryogenic shipping container in combination with a primary adsorbent 12, the primary adsorbent 12 will become saturated with liquid cryogen while the secondary adsorbent 14 will not be saturated. Thus, the secondary adsorbent 14 will have capacity to adsorb liquid cryogen that may desorb from the primary adsorbent 12. In certain aspects, the secondary adsorbent 14 has a second liquid cryogen adsorption rate of 0.1 L/hr per unit volume of adsorbent to 0.75 L/hr per unit volume of adsorbent. In certain aspects, the secondary adsorbent 14 has a second liquid cryogen adsorption rate of 0.15 L/hr per unit volume of adsorbent to 0.65 L/hr per unit volume of adsorbent, including from 0.2 L/hr per unit volume of adsorbent to 0.6 L/hr per unit volume of adsorbent, from 0.25 L/hr per unit volume of adsorbent to 0.6 L/hr per unit volume of adsorbent, from 0.3 L/hr per unit volume of adsorbent to 0.6 L/hr per unit volume of adsorbent, from 0.4 L/hr per unit volume of adsorbent to 0.6 L/hr per unit volume of adsorbent, and also including from 0.45 L/hr per unit volume of adsorbent to 0.55 L/hr per unit volume of adsorbent.

As seen in FIGS. 1 and 1A, the adsorbent system 10 includes a primary adsorbent 12 and a secondary adsorbent 14 that are provided as separate articles. For example, as seen in FIGS. 1 and 1A, the primary adsorbent 12 is provided as a plurality of porous enclosures 16 that contain an aerogel powder and/or aerogel chunks and the secondary adsorbent 14 is provided as a porous enclosure 18 that contains a fumed metal oxide powder. In certain aspects, the primary adsorbent 12 comprises an aerogel reinforced composite and the secondary adsorbent 14 comprises a porous enclosure 18 that contains a fumed metal oxide powder. In certain aspects, the primary adsorbent 12 comprises a plurality of porous enclosures 16 that contain an aerogel powder and/or aerogel chunks and the secondary adsorbent 14 comprises a plurality of porous enclosures 18 that contain a fumed metal oxide powder.

Alternatively, and as seen in FIGS. 2 and 2A, an adsorbent system 10a of the present disclosure may include a primary adsorbent 12a and a secondary adsorbent 14a that are provided as a unitary article. For example, as seen in FIGS. 2 and 2A, the adsorbent system 10a includes a primary adsorbent 12a with an aerogel reinforced composite and a secondary adsorbent 14a includes a porous enclosure 18a that contains a fumed metal oxide powder and that is attached to the primary adsorbent 12a. In certain aspects, the adsorbent system 10a comprises a primary adsorbent 12a that is separated from the secondary adsorbent 14a within the unitary article. For example, in certain aspects, the adsorbent system 10a comprises a porous enclosure (as previously described herein) that includes a first section for containing the primary adsorbent material 12a (e.g., an aerogel powder and/or aerogel chunks) and a second section for containing the secondary adsorbent material 14a (e.g., a fumed metal oxide).

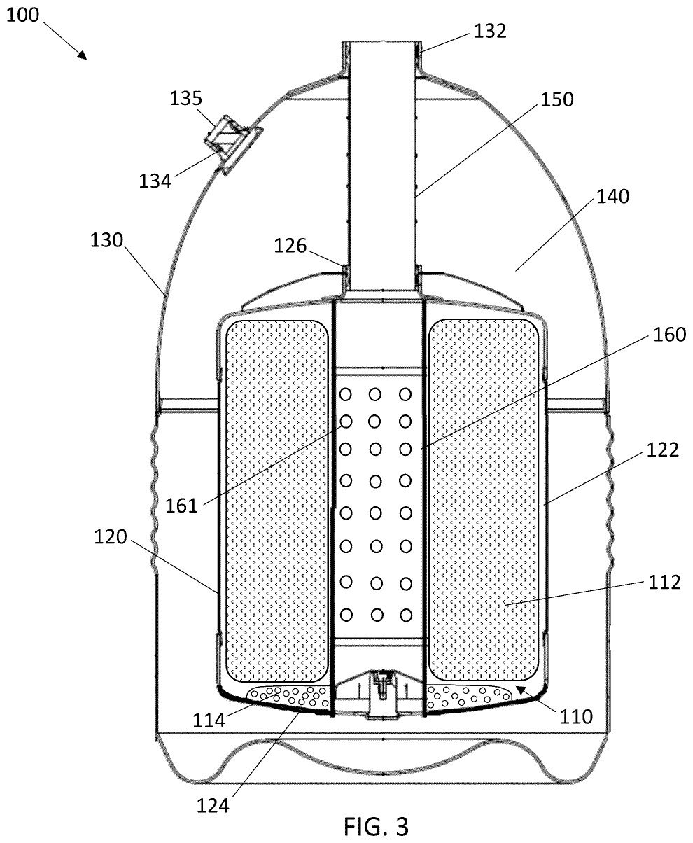

Referring now to FIG. 3, a dry vapor cryogenic shipping container 100 (hereinafter “shipping container”) according to the present disclosure is illustrated. The shipping container 100 includes an adsorbent system 110 includes a primary adsorbent 112 having a first liquid cryogen adsorption rate and a secondary adsorbent 114 having a second liquid cryogen adsorption rate, wherein a ratio of the first liquid cryogen adsorption rate to the second liquid cryogen adsorption rate is from 2:1 to 10:1. The adsorbent system 110, the primary adsorbent 112, and the secondary adsorbent 114 may comprise any of the materials and be configured in any of the ways previously described herein with respect to the adsorbent systems 10, 10a, the primary adsorbents 12, 12a, and the secondary adsorbents 14, 14a shown in FIGS. 1 and 1A and FIGS. 2 and 2A.

The shipping container 100 of the present disclosure can be configured as any type of conventional dry vapor cryogenic shipping container (e.g., a dewar-type container) but includes an adsorbent system 110 includes a primary adsorbent 112 and a secondary adsorbent 114 as described herein. As seen in FIG. 3, the shipping container 100 comprises an inner vessel 120 having an interior volume defined by at least one sidewall 122 and a bottom wall 124. An outer shell 130 surrounds and is separated from the inner vessel 120 to define an evacuable space 140 between the outer shell 130 and the inner vessel 120. The inner vessel 120 is suspended from the outer shell 130 by a neck tube 150. The neck tube 150 connects an open neck 126 of the inner vessel 120 to an open neck 132 of the outer shell 130. A cap assembly (not shown) can be removably inserted into the neck tube 150 to prevent heat losses through the neck tube 150 and to prevent foreign matter from entering into the inner vessel 120. The inner vessel 120, the outer shell 130, and the neck tube 150 may each be formed of a variety of metals and/or metal alloys including, but not limited to, aluminum and stainless steel.

The evacuable space 140 can be filled with an insulation material (not shown). To achieve a vacuum condition in the evacuable space 140, the air present in the evacuable space 140 can be removed through a conventional evacuation spud 134 using a conventional pumping system (not shown). After the evacuation has been completed, the evacuation spud 134 is hermetically sealed under vacuum in a manner well known in the art using, for example, a sealing plug and cap 135.

As shown in FIG. 3, the primary adsorbent 112 and the secondary adsorbent 114 are disposed within the interior volume of the inner vessel 120, with at least a portion of the secondary adsorbent 114 being positioned adjacent the bottom wall 124. In certain aspects, the primary adsorbent 112, the secondary adsorbent 114, or both are removably disposed within the interior volume of the inner vessel 120, which allows spent adsorbent 112, 114 to be removed from the shipping container 100 and replaced with fresh adsorbent 112, 114.

The shipping container 100 also includes a permeable core sleeve 160 disposed within the interior volume of the inner vessel 120 and at least partially encompassed by the adsorbent system 110. The permeable core sleeve 160 includes a plurality of openings or holes 161 that allow a liquid cryogen to pass through to the adsorbent system 110 when the shipping container 100 is charged with a liquid cryogen. In certain aspects, the permeable core sleeve 160 is removably disposed within the interior volume of the inner vessel 120 such that the permeable core sleeve 160 can be removed from the shipping container via the neck tube 150 so as to provide access for removing and replacing the adsorbent system 110 within the inner vessel 120. In addition, the permeable core sleeve 160 is configured to removably receive at least one canister (not shown) that can retain a plurality of sample holders (e.g., vials, canes, straws, pouches, goblets, ampules) that are at least partially filled with a sample of material that requires a low temperature (e.g., from −70° C. to −196° C. or less) during shipment. The permeable core sleeve 160 may be formed as a tube with open ends having a cross-sectional shape including, but not limited to, circular, square, and rectangular. The permeable core sleeve 160 may be formed of any material (e.g., aluminum, other metals, or plastic) that can remain structurally stable and retain its form after being repeatedly subjected to cold shocks from a liquid cryogen such as liquid nitrogen.

The adsorbent system 110 may be configured as a unitary article that removably receives the permeable core sleeve 160. For example, the adsorbent system 110 may be configured as shown in FIGS. 2 and 2A that receives a permeable core sleeve 160 formed as a tube having open ends and a generally circular cross-section.

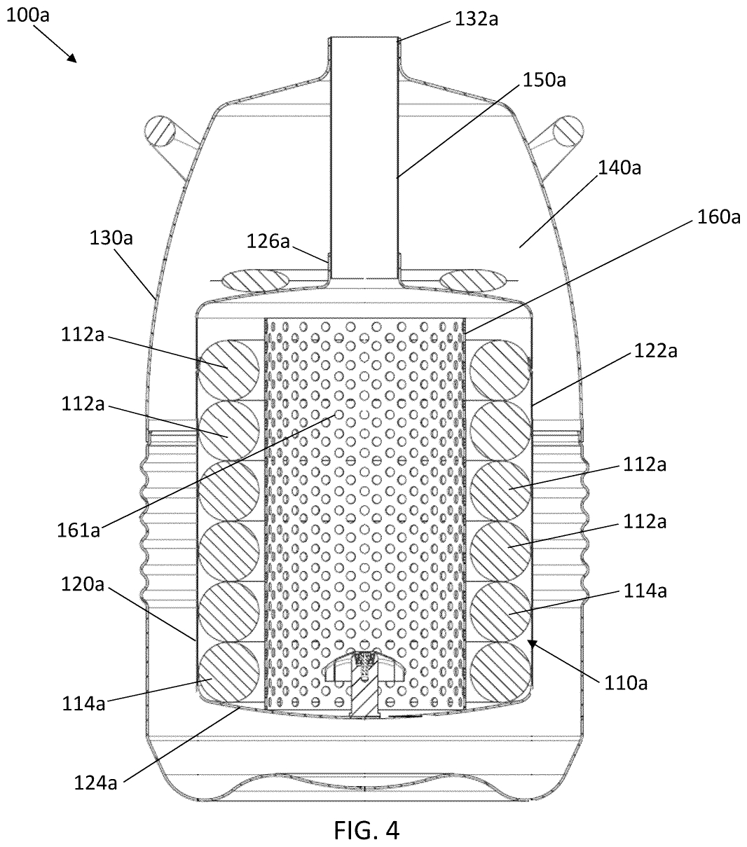

Referring now to FIG. 4, a shipping container 100a according to the present disclosure is illustrated. The shipping container 100a includes an adsorbent system 110a includes a plurality of primary adsorbent members 112a having a first liquid cryogen adsorption rate and a plurality of secondary adsorbent members 114a having a second liquid cryogen adsorption rate, wherein a ratio of the first liquid cryogen adsorption rate to the second liquid cryogen adsorption rate is from 2:1 to 10:1. The adsorbent system 110a, the primary adsorbent members 112a, and the secondary adsorbent members 114a may comprise any of the materials and be configured in any of the ways previously described herein. In FIG. 4, the plurality of primary adsorbent members 112a comprise a porous enclosure containing an aerogel (e.g., aerogel powder or aerogel chunks), and the plurality of secondary adsorbent members 114a comprise a porous enclosure containing a fumed metal oxide (e.g., fumed silica, fumed calcium silicate, or combinations thereof).

As seen in FIG. 4, the shipping container 100a comprises an inner vessel 120a having an interior volume defined by at least one sidewall 122a and a bottom wall 124a. An outer shell 130a surrounds and is separated from the inner vessel 120a to define an evacuable space 140a between the outer shell 130a and the inner vessel 120a. The inner vessel 120a is suspended from the outer shell 130a by a neck tube 150a. The neck tube 150a connects an open neck 126a of the inner vessel 120a to an open neck 132a of the outer shell 130a. A cap assembly (not shown) can be removably inserted into the neck tube 150a to prevent heat losses through the neck tube 150a and to prevent foreign matter from entering into the inner vessel 120a. The inner vessel 120a, the outer shell 130a, and the neck tube 150a may each be formed of a variety of metals and/or metal alloys including, but not limited to, aluminum or stainless steel.

The evacuable space 140a can be filled with an insulation material (not shown). To achieve a vacuum condition in the evacuable space 140a, the air present in the evacuable space 140a can be removed through a conventional evacuation spud (not shown) using a conventional pumping system (not shown). After the evacuation has been completed, the evacuation spud (not shown) is hermetically sealed under vacuum in a manner well known in the art using, for example, a sealing plug and cap (not shown).

As shown in FIG. 4, the primary adsorbent members 112a and the secondary adsorbent members 114a are disposed within the interior volume of the inner vessel 120a. At least a portion of a secondary adsorbent member 114a is positioned adjacent the bottom wall 124. In certain aspects, the primary adsorbent members 112a, the secondary adsorbent members 114a, or both are removably disposed within the interior volume of the inner vessel 120a, which allows spent adsorbent members 112a, 114a to be removed from the shipping container 100a and replaced with fresh adsorbent members 112a, 114a.

The shipping container 100a also includes a permeable core sleeve 160a disposed within the interior volume of the inner vessel 120a and at least partially encompassed by the adsorbent system 110a. The permeable core sleeve 160a includes a plurality of openings or holes 161a that allow a liquid cryogen to pass through to the adsorbent system 110a when the shipping container 100a is charged with the liquid cryogen. In certain aspects, the permeable core sleeve 160a is removably disposed within the interior volume of the inner vessel 120a such that the permeable core sleeve 160a can be removed from the shipping container via the neck tube 150a so as to provide access for removing and replacing the primary and secondary adsorbent members 112a, 114a within the inner vessel 120a. In addition, the permeable core sleeve 160a is configured to removably receive at least one canister (not shown) that can retain a plurality of sample holders (e.g., vials, canes, straws, pouches, goblets, ampules) that are at least partially filled with a sample of material that requires a low temperature (e.g., from −70° C. to −196° C. or less) during shipment. The permeable core sleeve 160a may be a sheet of material (e.g., aluminum) formed as a tube with open ends having a cross-sectional shape including, but not limited to, circular, square, and rectangular. The permeable core sleeve 160a may be formed of any material (e.g., aluminum, other metals, or plastic) that can remain structurally stable and retain its form after being repeatedly subjected to cold shocks from a liquid cryogen such as liquid nitrogen.

As previously described, the adsorbent system 110, 110a comprises a primary adsorbent 112, 112a and a secondary adsorbent 114, 114a having different liquid cryogen adsorption rates, with the primary adsorbent 112, 112a having the ability to adsorb liquid cryogen at a rate that is two to ten times higher than the secondary adsorbent 114, 114a. Accordingly, a shipping container 100, 100a having the adsorbent system 110, 110a of the present disclosure can be quickly charged (e.g., within 2 hours to 4 hours) with a liquid cryogen due to the properties associated with the primary adsorbent 112, 112a. During the charging process, the primary adsorbent 112, 112a can become saturated with liquid cryogen while the secondary adsorbent 114, 114a will not be saturated due to its slower liquid cryogen adsorption rate. Positioning at least a portion of the secondary adsorbent 114, 114a adjacent the bottom wall 124, 124a of the inner vessel 120, 120a will allow the secondary adsorbent 114, 114a, which still has some amount of liquid cryogen adsorption capacity, to adsorb liquid cryogen that may desorb from the primary adsorbent 112, 112a and migrate towards the bottom wall 124, 124a of the inner vessel 120, 120a. Thus, the adsorbent system 110, 110a ensures fast charging of a liquid cryogen (e.g., 2 hours to 4 hours), while also ensuring that the shipping container 100, 100a does not contain free liquid cryogen after charging.

In certain aspects of the present disclosure, the shipping container 100, 100a includes the primary adsorbent 112, 112a and the secondary adsorbent 114, 114a such that a ratio of a mass of the primary adsorbent 112, 112a to a mass of the secondary adsorbent 114, 114a is from 1:22 to 1:5, including from 1:20 to 1:5, from 1:16 to 1:5, from 1:12 to 1:5, from 1:10 to 1:5, from 1:8 to 1:5, and also including from 1:6 to 1:5. In certain aspects of the present disclosure, the shipping container 100, 100a includes the primary adsorbent 112, 112a and the secondary adsorbent 114, 114a such that a ratio of a volume of the primary adsorbent 112, 112a to a volume of the secondary adsorbent 114, 114a is from 1:1 to 4:1, including from 1.5:1 to 4:1, from 1.75:1 to 4:1, from 2:1 to 4:1, from 2.5:1 to 4:1, from 3:1 to 4:1, and also including from 3.5:1 to 4:1.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

While various inventive aspects, concepts and features may be described and illustrated herein in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present disclosure. Still further, while various alternative embodiments as to the various inventive aspects, concepts and features—such as alternative materials, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present disclosure even if such embodiments are not expressly disclosed herein. Additionally, even though some inventive aspects, concepts, or features may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, descriptions of exemplary methods or processes are not limited to inclusion of all steps as being required in all cases, nor is the order that the steps are presented to be construed as required or necessary unless expressly so stated or the context dictates otherwise.

What is claimed is:

1. A dry vapor cryogenic shipping container comprising:
an inner vessel having an interior volume defined by at least one sidewall and a bottom wall;
an outer shell that surrounds and is separated from the inner vessel to define an evacuable space between the outer shell and the inner vessel; and
an adsorbent system comprising:
a primary adsorbent having a first liquid cryogen adsorption rate disposed within the interior volume of the inner vessel; and
a secondary adsorbent having a second liquid cryogen adsorption rate disposed within the interior volume of the inner vessel;
wherein a ratio of the first liquid cryogen adsorption rate to the second liquid cryogen adsorption rate is from 2:1 to 10:1.

2. The dry vapor cryogenic shipping container of claim 1, wherein at least a portion of the secondary adsorbent is positioned adjacent the bottom wall.

3. The dry vapor cryogenic shipping container of claim 1, wherein the ratio of the first liquid cryogen adsorption rate to the secondary liquid cryogen adsorption rate is from 4:1 to 6:1.

4. The dry vapor cryogenic shipping container of claim 1, wherein a ratio of a mass of the primary adsorbent to a mass of the secondary adsorbent is from 1:22 to 1:5.

5. The dry vapor cryogenic shipping container of claim 1, wherein a ratio of a volume of the primary adsorbent to a volume of the secondary adsorbent is from 1:1 to 4:1.

6. The dry vapor cryogenic shipping container of claim 1, wherein the primary adsorbent comprises an aerogel and the secondary adsorbent comprises a fumed metal oxide.

7. The dry vapor cryogenic shipping container of claim 1, wherein the primary adsorbent comprises an aerogel reinforced composite and the secondary adsorbent comprises at least one of a fumed silica and a fumed calcium silicate.

8. The dry vapor cryogenic shipping container of claim 1, wherein at least one of the primary adsorbent and the secondary adsorbent are contained within a porous enclosure.

9. An adsorbent system for a dry vapor cryogenic shipping container comprising:
a primary adsorbent having a first liquid cryogen adsorption rate; and
a secondary adsorbent having a second liquid cryogen adsorption rate,
wherein a ratio of the first liquid cryogen adsorption rate to the second liquid cryogen adsorption rate is from 2:1 to 10:1.

10. The adsorbent system of claim 9, wherein the ratio of the first liquid cryogen adsorption rate to the secondary liquid cryogen adsorption rate is from 4:1 to 6:1.

11. The adsorbent system of claim 9, wherein the primary adsorbent and the secondary adsorbent are provided as separate articles.

12. The adsorbent system of claim 9, wherein the primary adsorbent and the secondary adsorbent are provided as a unitary article.

13. The adsorbent system of claim 9, wherein the primary adsorbent comprises an aerogel and the secondary adsorbent comprises a fumed metal oxide.

14. The adsorbent system of claim 9, wherein the primary adsorbent comprises an aerogel reinforced composite and the secondary adsorbent comprises at least one of a fumed silica and a fumed calcium silicate.

15. The adsorbent system of claim 9, wherein at least one of the primary adsorbent and the secondary adsorbent are contained within a porous enclosure.

16. The adsorbent system of claim 15, wherein the primary adsorbent comprises an aerogel reinforced composite attached to the porous enclosure.

17. The adsorbent of claim 9, wherein the primary adsorbent comprises at least one porous enclosure containing the aerogel and the secondary adsorbent comprises at least one secondary porous enclosure containing the fumed metal oxide, and wherein the at least one porous of the primary adsorbent is attached to the at least one porous enclosure of the secondary adsorbent.

18. A method of storing a liquid cryogen in a dry vapor cryogenic shipping container, the shipping container comprising a primary adsorbent having a first liquid cryogen adsorption rate and a secondary adsorbent having a second liquid cryogen adsorption rate, wherein a ratio of the first liquid cryogen adsorption rate to the second liquid cryogen adsorption rate is from 2:1 to 10:1, the method comprising:
filling an inner vessel of the shipping container with the liquid cryogen;
waiting for the primary adsorbent to be fully charged with liquid cryogen; and
closing the shipping container after the primary adsorbent is fully charged with the liquid cryogen and before the secondary adsorbent is fully charged with the liquid cryogen.

19. The method of claim 18, wherein the primary adsorbent is fully charged with the liquid cryogen after 2 hours to 4 hours.

20. The method of claim 18, further comprising emptying unabsorbed liquid cryogen from the shipping container prior to the step of closing the shipping container.
